(19) United States
(12) Patent Application Publication
(10) Pub. No.: US 2014/0016005 A1
(43) Pub. Date: Jan. 16, 2014

(54) INFORMATION PROCESSING APPARATUS, INFORMATION PROCESSING METHOD, AND INFORMATION PROCESSING PROGRAM

(71) Applicant: Sony Corporation, Tokyo (JP)

(72) Inventor: Koichiro Kishima, Kanagawa (JP)

(21) Appl. No.: 13/910,533

(22) Filed: Jun. 5, 2013

(30) Foreign Application Priority Data
Jul. 13, 2012 (JP) 2012-157242

(51) Int. Cl. H04N 5/367

(52) U.S. Cl. CPC H04N 5/367
USPC 348/246

(57) ABSTRACT

There is provided an information processing apparatus, including: an image obtaining section configured to obtain a RAW image, the RAW image being taken by an imaging unit, the imaging unit including an image sensor; and a controller configured to cause the imaging unit to preliminarily photograph a preliminary photographing object, and to obtain the RAW image as a first RAW image, to specify a defective pixel of the first RAW image based on the amount of difference between a value of a target pixel and a value of a neighboring pixel around the target pixel, and to create defective position data, to cause the imaging unit to actually photograph an actual photographing object, and to obtain the RAW image as a second RAW image, and to correct a luminance value of the second RAW image based on the defective position data.

### BACKGROUND

The present disclosure relates to an information processing apparatus configured to correct a RAW image, which includes abnormal luminance values of defective pixels of an image sensor, at high speed. The present disclosure further relates to an information processing method and an information processing program.

An image sensor, which includes defective pixels, takes an image as a RAW image. In general, the median filter is used to eliminate abnormal luminance values of the RAW image (for example, see Japanese Patent Application Laid-open No. H09-270962.). The calculation of the median filter includes a lot of conditional branching processing in loop processing. The processing speed is slow in general.

Further, recently, there is known a technical field called GPGPU (General-purpose calculation on graphics processors). According to the GPGPU, a GPU (Graphics Processing Unit) for graphic rendering is installed in a computing machine, and the GPU is used for not only rendering but also other numerical calculation.

A GPU is low in cost, readily accessible, and capable of realizing calculation at high speed. Because of this, it is possible to develop an editing system including a GPU at low cost. The GPU processes special effects of an image.

However, even if a program for a GPU is merely created and executed, it does not mean that high-seed calculation is realized easily. In developing a program, it is necessary to devise an image processing algorithm, and to devise how the program is installed. As a result, an image large in size may be processed in real time, and image processing of which calculation amount is large may be realized in real time.

Recently, there are disclosed some technologies, each of which devises high-speed calculation using a GPU.

For example, Japanese Patent Application Laid-open No. 2010-130696 discloses the following technology. That is, a GPU executes some processing steps and a CPU executes the other processing steps when decoding a video signal. As a result, the workload of the GPU and the workload of the CPU are balanced. According to the disclosure, the following module may be realized effectively. That is, data communication between the CPU and the GPU is minimized, the workload of the GPU and the workload of the CPU are balanced, and the GPU offloads the workload of the CPU.

### SUMMARY

In the past, the GPGPU may not execute arithmetic processing of the median filter from a viewpoint of characteristics of the arithmetic processing. Because of this, the GPGPU may not execute calculation, and defective pixel values of a RAW image may thus not be corrected at high speed.

In view of the above-mentioned circumstances, it is desirable to provide an information processing apparatus, an information processing method, and an information processing program capable of correcting defective pixel values of a RAW image at high speed.

(1) According to an embodiment of the present technology, there is provided an information processing apparatus, including: an image obtaining section configured to obtain a RAW image, the RAW image being taken by an imaging unit, the imaging unit including an image sensor; and a controller configured to cause the imaging unit to preliminarily photograph a preliminary photographing object, and to obtain the RAW image as a first RAW image, to specify a defective pixel of the first RAW image based on the amount of difference between a value of a target pixel and a value of a neighboring pixel around the target pixel, and to create defective position data, to cause the imaging unit to actually photograph an actual photographing object, and to obtain the RAW image as a second RAW image, and to correct a luminance value of the second RAW image based on the defective position data.

In general, the median filter executes defective pixel value correction processing as a series of processing. According to the present technology, the defective pixel value correction processing is divided into two processes. One process is until defective pixels are specified. The other process is after the defective pixels are specified and until luminance values are actually corrected. Further, the process of taking images is divided into preliminary photographing and actual photographing. As a result, the processing method executed by a controller may be optimized for each processing. Luminance values of defective pixel may be corrected at high speed.

(2) According to an embodiment of the present technology, there is provided an information processing apparatus, in which the controller includes a first arithmetic processor configured to cause the imaging unit to preliminarily photograph a preliminary photographing object, and to obtain the first RAW image, to specify a defective pixel of the first RAW image based on the amount of difference between a value of a target pixel and a value of a neighboring pixel around the target pixel, and to create defective position data, and to cause the imaging unit to actually photograph an actual photographing object, and a second arithmetic processor configured to correct a luminance value of the second RAW image based on the defective position data, the second RAW image being obtained by the actual photographing.

According to the present technology, the controller includes two arithmetic processors. Because of this, one arithmetic processor may be optimized for the process until defective pixels are specified. The other arithmetic processor may be optimized for the process after the defective pixels are specified and until luminance values are actually corrected. As a result, luminance values of defective pixel may be corrected at higher speed.

(3) According to an embodiment of the present technology, there is provided an information processing apparatus, in which the second arithmetic processor may be configured to calculate an average of luminance values of neighboring pixels around a defective position for each pixel color, and to correct the luminance value of the defective position with the average value.

The median filter obtains the median to correct luminance values of defective pixels. Alternatively, the present technology uses the average value of luminance values of neighboring pixels around a defective position. Because of this, it is not necessary to sort luminance values of a plurality of calculation-target pixels and to calculate the median to thereby obtain a luminance value to be corrected, just as the median filter does. As a result, luminance values of defective pixel may be corrected at higher speed.

(4) According to an embodiment of the present technology, there is provided an information processing apparatus, in which the first arithmetic processor may be configured to set a photographing condition in the imaging unit, the photographing condition of the preliminary photographing being capable of emphasizing a defective characteristic of each pixel of the image sensor more than a photographing condition of the actual photographing does.

According to the present technology, the number of defective pixels in the preliminary photographing is larger than the number of defective pixels in the actual photographing. In other words, the preliminary photographing employs a photographing condition under which blink-defective pixels are certainly specified as defects. As a result, it is possible to certainly correct luminance values of defective pixels of a RAW image obtained in the actual photographing.

(5) According to an embodiment of the present technology, there is provided an information processing apparatus, in which the second arithmetic processor may be a graphics processing unit.

According to the present technology, a graphics processing unit is used as the second arithmetic processor. The graphics processing unit is capable of executing parallel arithmetic processing at high speed. As a result, luminance values of defective pixel may be corrected at higher speed.

(6) According to an embodiment of the present technology, there is provided an information processing method, including: obtaining, by an image obtaining section, a RAW image, the RAW image being taken by an imaging unit, the imaging unit including an image sensor; causing, by a controller, the imaging unit to preliminarily photograph a preliminary photographing object, and to obtain the RAW image as a first RAW image; specifying, by the controller, a defective pixel of the first RAW image based on the amount of difference between a value of a target pixel and a value of a neighboring pixel around the target pixel, and to create defective position data; causing, by the controller, the imaging unit to actually photograph an actual photographing object, and to obtain the RAW image as a second RAW image; and correcting, by the controller, a luminance value of the second RAW image based on the defective position data.

(7) According to an embodiment of the present technology, there is provided an information processing program, causing a computer to function as: an image obtaining section configured to obtain a RAW image, the RAW image being taken by an imaging unit, the imaging unit including an image sensor; and a controller configured to cause the imaging unit to preliminarily photograph a preliminary photographing object, and to obtain the RAW image as a first RAW image, to specify a defective pixel of the first RAW image based on the amount of difference between a value of a target pixel and a value of a neighboring pixel around the target pixel, and to create defective position data, to cause the imaging unit to actually photograph an actual photographing object, and to obtain the RAW image as a second RAW image, and to correct a luminance value of the second RAW image based on the defective position data.

As described above, according to the present technology, it is possible to correct defective pixel values of a RAW image at high speed.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing the basic scheme of the median filter;

FIG. 2 is a diagram showing an example of determining if the luminance value of a target pixel is replaced or not based on comparison between the luminance value of the target pixel and a threshold;

FIG. 3 shows an example in which always-defective pixels and blink-defective pixels are measured;

FIG. 4 is a diagram showing the relation between photographing conditions and defects;

FIG. 5 is a diagram showing an example of a 1CCD RGB array;

FIG. 6 is a diagram showing (nine) median-filtered red pixels in the 1CCD RGB array;

FIG. 7 is a diagram showing (five) median-filtered red pixels in the 1CCD RGB array;

FIG. 8 is a diagram showing a green target pixel G1 and median-filtered pixels (target pixel G1 and neighboring pixels G2, five in total) in the 1CCD RGB array;

FIG. 9 is a diagram showing a green target pixel G1 and median-filtered pixels (target pixel G1 and neighboring pixels G1, nine in total) in the 1CCD RGB array;

FIG. 10 is a diagram showing the green target pixel G1 and median-filtered pixels (target pixel G1 and neighboring pixels G1, five in total) in the 1CCD RGB array;

FIG. 11 is a diagram showing an example of the 1CCD RGBW array;

FIG. 12 is a diagram showing (five) median-filtered red pixels in the 1CCD RGBW array;

FIG. 13 is a diagram showing the green target pixel and median-filtered pixels (target pixel G and neighboring pixels G, three in total) in the 1CCD RGBW array;

FIG. 14 is a diagram showing the white target pixel and median-filtered pixels (target pixel W and neighboring pixels W, five in total) in the 1CCD RGBW array;

FIG. 15 is a diagram showing an example of the array of a red image sensor of the 3CCD RGB array;

FIG. 16 is a diagram showing (nine) median-filtered red pixels in the 3CCD RGB array;

FIG. 17 is a diagram showing (five) median-filtered red pixels in the 3CCD RGB array;

FIG. 18 is a diagram showing (four) red neighboring pixels of which average is obtained to correct a red defective pixel value in the 1CCD RGB array;

FIG. 19 is a diagram showing an example of a calculation method of correcting red and blue defective pixel values in the 1CCD RGB array;

FIG. 20 is a diagram showing (four) green neighboring pixels of which average is obtained to correct a green defective pixel value in the 1CCD RGB array;

FIG. 21 is a diagram showing an example of a calculation method of correcting green defective pixel values in the 1CCD RGB array;

FIG. 22 is a diagram showing (four) red neighboring pixels of which average is obtained to correct a red defective pixel value in the 1CCD RGBW array;

FIG. 23 is a diagram showing (two) green neighboring pixels of which average is obtained to correct a green defective pixel value in the 1CCD RGBW array;

FIG. 24 is a diagram showing (four) white neighboring pixels of which average is obtained to correct a white defective pixel value in the 1CCD RGBW array;

FIG. 25 is a diagram showing (four) unicolor neighboring pixels of which average is obtained to correct a unicolor defective pixel value in the 3CCD RGB array or the 1CCD black-and-white array;

FIG. 26 is a diagram showing the configuration of an image obtaining apparatus 100, which includes an information processing apparatus of this embodiment, and is configured to obtain a fluorescent image;

FIG. 27 is a block diagram showing the hardware configuration of an information processing apparatus 20 of the present technology;

FIG. 28 is a functional block diagram showing the information processing apparatus 20 of the present technology; and

FIG. 29 is a flowchart showing the overall flow of defective pixel detection and defective pixel value correction.

### DETAILED DESCRIPTION OF EMBODIMENTS

Hereinafter, an embodiment of the present disclosure will be described with reference to the drawings.

### First Embodiment

First, the median filter will be described. Then, problems of a related art and the gist of the present technology will be described. Further, an environment in which the present technology is used will be described.

[Median Filter]

An imaging area of an image sensor includes pixels. The pixels include defective pixels. When an image is taken, the defective pixels output abnormal luminance values. The abnormal luminance value is totally different from luminance values of neighboring pixels. The median filter is configured to eliminate such abnormal luminance values.

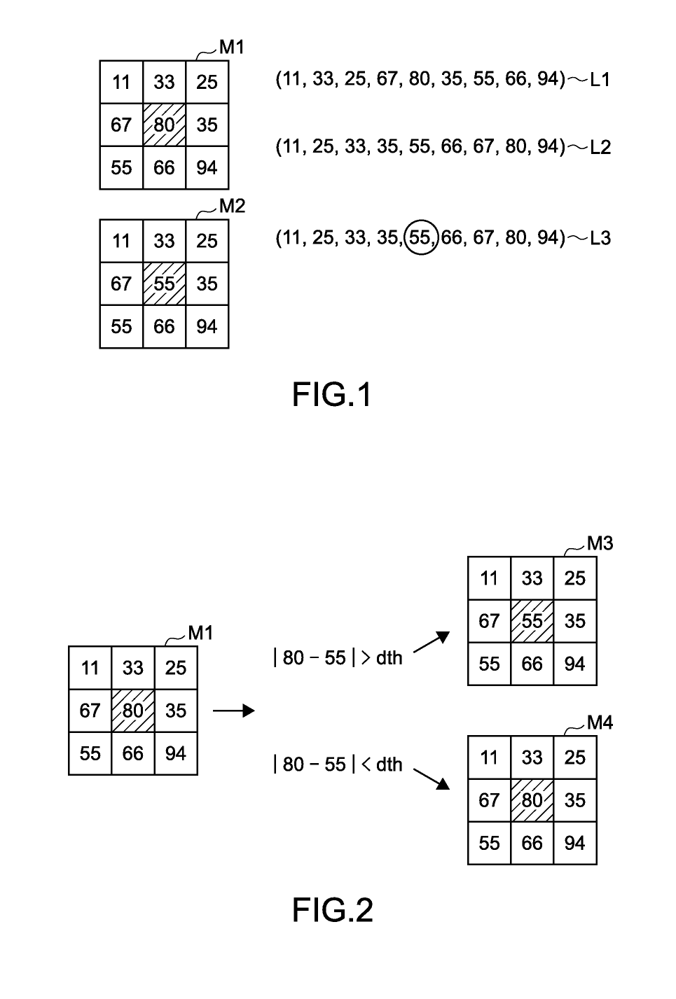

FIG. 1 is a diagram showing the basic scheme of the median filter. Let's pay attention to a specific pixel (central hatched portion of matrix M1), and to the luminance value of the pixel and the luminance values of the eight neighboring pixels. First, the luminance values are written down from the upper left pixel of the matrix M1 in order. A sequence L1 is written down. The values are 11, 33, 25, 67, 80, 35, 55, 66, 94 from the left in order.

Next, the luminance values of the sequence L1 are sorted from the smallest value in order. A sequence L2 shows the sorted sequence.

Finally, the median value, i.e., 55, is obtained as shown in a sequence L3. The value of the target pixel, i.e., 80, is replaced with 55. A matrix M2 shows that the value of the target pixel is replaced.

The basic scheme of the median filter has been described above. An abnormal value is totally different from luminance values of neighboring pixels, and is an outstanding value. Note that, if the median filter is used as it is, there is a high possibility that a luminance value, which is not such an abnormal value, is also eliminated. In view of this, in practice, a threshold is employed. Whether to replace a luminance value or not is determined based on the threshold.

FIG. 2 is a diagram showing an example of determining if the luminance value of a target pixel is replaced or not based on comparison between the luminance value of the target pixel and a threshold. Description will be made with reference to the example of FIG. 1. First, the original luminance value of the target pixel of the matrix M1 is 80. Further, the median luminance value is 55. Here, the differential between a luminance value before replacement and a luminance value replacement candidate is obtained. The differential is compared to a preset threshold (dth).

Let's say that the differential is larger than the threshold (for example, dth=20) (|80-55|>dth). In this case, the luminance value of the target pixel is to be replaced. So, as shown in a matrix M3, the luminance value of the target pixel is replaced with the replacement candidate value 55. Let's say that the differential is smaller than the threshold (for example, dth=30) (180-551<dth). In this case, the luminance value of the target pixel is not to be replaced. So as shown in a matrix M4, the luminance value is the original value.

A threshold is appropriately set in this way. As a result, it is possible to correct only an obviously abnormal value by means of the median filter.

[Problems of Related Art and Gist of the Present Technology]

As described above, the median filter is configured to eliminate abnormal luminance values of defective pixels of an image sensor. However, as described above, the arithmetic processing of the median filter includes the luminance value replacement process, the conditional branching process, and the like. The conditional branching process compares a differential with a threshold. Because of this, it is difficult to execute the arithmetic processing at higher speed.

Further, in recent years, hardware called GPGPU (General-purpose calculation on graphics processors) is used in the field of image processing in order to speed up the processing by means of parallel calculation. The GPGPU is capable of executing simple calculation in parallel, and of processing the simple calculation at high speed. However, it is difficult for the GPGPU to execute loop processing such as replacement of values, and to execute conditional branching processing such as comparison of larger and smaller values. Because of this, even if a GPGPU executes the median filter processing, a GPGPU may not speed up the median filter processing greatly, and the merit of a GPGPU may not be received greatly.

In view of the above-mentioned circumstances, according to the present technology, the median filter processing is clearly divided into two processes, i.e., defective pixel detection and defective pixel value correction. Further, hardware for executing each processing is optimized, and an operation method is optimized.

First, optimization of hardware will be described. In the defective pixel detection, luminance values are sorted, and the luminance value of a target pixel is compared with the median luminance value. The processing includes a lot of conditional branching processing. A CPU is suitable to execute the processing.

In the defective pixel value correction, the luminance value of a defective pixel is corrected by means of simple arithmetic processing (described later). Examples of the simple arithmetic processing include addition, multiplication, unconditional move of elements in an array, and bit shift. A GPGPU is suitable to execute the simple arithmetic processing.

Next, optimization from a viewpoint of operation will be described. It is not necessary to detect defective pixels every time an image is taken. Defective pixels may be detected when a series of sample slides are replaced, once every morning, or the like. That is, the defective pixel detection processing is executed infrequently. So, even if it takes some time to detect defective pixels, photographing processing of a sample is less affected by the defective pixel detection processing.

To the contrary, it is necessary to correct defective pixel values every time an image is taken. Because of this, it is desirable to speed up the defective pixel value correction by using a GPGPU, and to minimize the correction processing time even in a case of continuous shooting. As described above, the processing which takes longer time is executed infrequently, and the processing which takes shorter time is executed frequently. As a result, the operation method is optimized.

Problems of a related art and the gist of the present technology have been described above.

[Defective Pixel Detection Processing]

Next, the defective pixel detection processing will be described. In the defective pixel detection processing, the positions of defective pixels are specified out of pixels of an imaging area of an image sensor based on a shot RAW image. In the processing, it is necessary to pay attention to the presence of blink defect. According to the blink defect, a pixel turns to be a defective pixel and outputs an abnormal luminance value under some photographing conditions, and the same pixel does not turn to be a defective pixel and outputs a normal luminance value under the other photographing conditions.

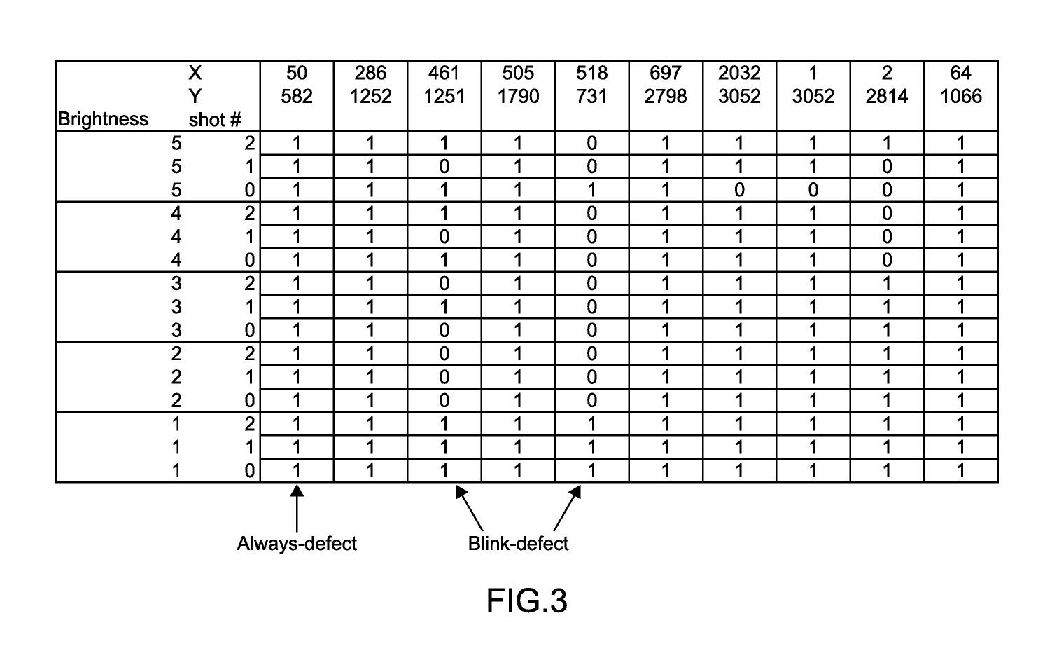

FIG. 3 shows an example in which always-defective pixels and blink-defective pixels are measured. In this example, a 24-megapixel image sensor is used, and exposure is performed for one second at the ISO 400 speed. The median filter is used to determine defects where the threshold dth is 700. The row of the table shows five different ranks of photographing brightness, i.e., 1 (no lighting) to 5 (brightest).

Further, images are taken three times (shot #0 to 2) under each brightness. The column of the table shows the xy coordinate of a defective position. “1” means that the differential value between the luminance value of a target pixel and the median luminance value is more than 700. “0” means that the differential value is 700 or less.

As shown in FIG. 3, the pixel of the coordinate (50, 582) is always defective. Meanwhile, the pixel of the coordinate (461, 1251) or the pixel of the coordinate (518, 731) has normal and abnormal luminance values. The pixel of the coordinate (461, 1251) or the pixel of the coordinate (518, 731) is determined as a defective pixel sometimes, and is not determined as a defective pixel sometimes.

Photographing for detecting defective pixels is referred to as “preliminary photographing”.

Photographing of a sample will be referred to as “actual photographing”. In a case of an always-defective pixel, the defective pixel is detected in the preliminary photographing. An image obtained in the actual photographing may be appropriately corrected. However, in a case of a blink-defective pixel, a defective pixel is not detected in the preliminary photographing. If the blink-defective pixel turns to be a defective pixel at the time of actual photographing, an image obtained in the actual photographing may not be corrected.

In view of the above, according to the present technology, the photographing condition of the preliminary photographing is different from the photographing condition of the actual photographing. Specifically, under the former condition, defective pixels are more likely to be detected than the latter condition. The problem of blink defects is dealt with in this manner.

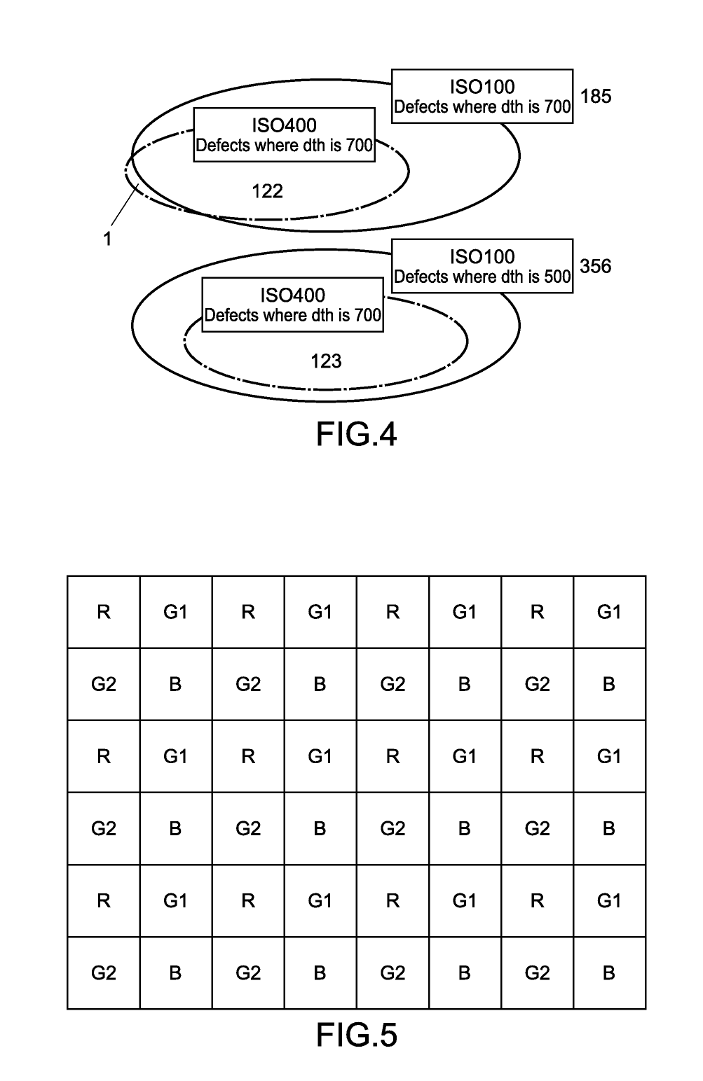

FIG. 4 is a diagram showing the relation between photographing conditions and defects. In FIG. 4, each defect is specified based on the coordinate, and the number of defects is counted. An image sensor uses a 24-megapixel image sensor, sets the temperature at 25° C., and measures defects.

The upper portion of FIG. 4 shows that the number of defects is 123 under the following condition. That is, the ISO speed is 400, exposure is performed for one second, and the median filter specifies defective pixels where the threshold is 700. Further, 122 defects out of 123 defects are included in 185 defects, which are obtained by specifying defective pixels under the following condition. That is, the ISO speed is 100, exposure is performed for four seconds, and the threshold is 700. However, one defect out of 123 defects is not included in the 185 defects.

That is, it means the following fact. The preliminary photographing is performed and defects are detected under the following condition. That is, the ISO speed is 100, exposure is performed for four seconds, and the threshold is 700. In this case, one defect is not corrected in the actual photographing.

The lower portion of FIG. 4 shows that all the above-mentioned 123 defects are included in 356 defects, which are detected under the following condition. That is, the ISO speed is 100, exposure is performed for four seconds, and the threshold is 500.

The photographing condition of preliminary photographing is set appropriately, and the threshold of the median filter for detecting defects is set appropriately in this manner. Then, defective pixels, which include all the defects generated in the actual photographing, may be detected.

Note that, in this example, 123 defects are generated in the actual photographing. Meanwhile, 356 defects are corrected. That is, originally normal 233 (=356-123) pixel values are corrected. However, the number 233 out of 24 megapixels, i.e., the number of all the pixels, may be neglected from a viewpoint of an effective pixel ratio.

To certainly correct luminance values of defective pixels has a greater influence on a correction result than to correct luminance values of the small number of normal pixels. It is thus important to certainly correct luminance values of defective pixels.

Hereinafter, the defective pixel detection methods of the 1CCD RGB array, the 1CCD RGBW array, the 3CCD RGB array, and the 1CCD black-and-white array will be described, respectively. The 1CCD RGB array, the 1CCD RGBW array, the 3CCD RGB array, and the 1CCD black-and-white array are examples of a pixel array of an image sensor.

[Example 1 of Defective Pixel Detection Method (1CCD RGB Array)]

Here, the defective pixel detection method, in which the pixel array of an image sensor is the 1CCD RGB array, will be described. FIG. 5 is a diagram showing an example of the 1CCD RGB array. R shows a pixel having a red optical filter. B shows a pixel having a blue optical filter. G shows a pixel having a green optical filter. Note that, to make the description easier, the green pixels include G1 and G2.

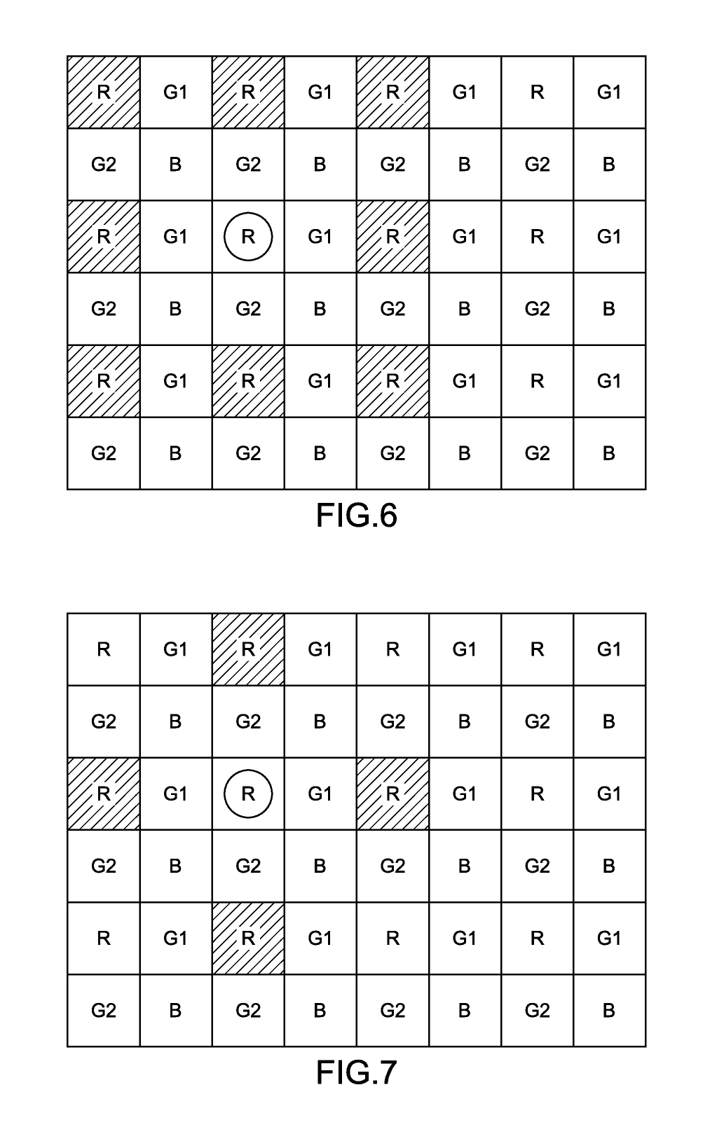

FIG. 6 is a diagram showing (nine) median-filtered red pixels in the 1CCD RGB array. Basically, the median filter is used to detect defective pixels. However, it is not necessary to use the median filter. Defective pixels may be detected based on another algorithm.

As shown in FIG. 6, the luminance values of the eight hatched pixels and the circled target pixel are median-filtered to determine a defect of the target pixel. It should be noted that pixels having the same color are median-filtered. The same applies to the other colors and the other pixel arrays of an image sensor.

Details of the median filter are different depending on photographing equipment. So they will not be described here.

Note that, in FIG. 6, nine pixels are median-filtered in total. Alternatively, pixels, of which positions are shown in FIG. 7, may be median-filtered. FIG. 7 is a diagram showing (five) median-filtered red pixels in the 1CCD RGB array. The number of the median-filtered pixels is decreased. As a result, it is possible to reduce the time of the luminance value sorting processing.

The case where red pixels are median-filtered has been described above. In the 1CCD RGB array, the array of the blue pixels is the same as the array of the red pixels. So the blue pixels will not be described.

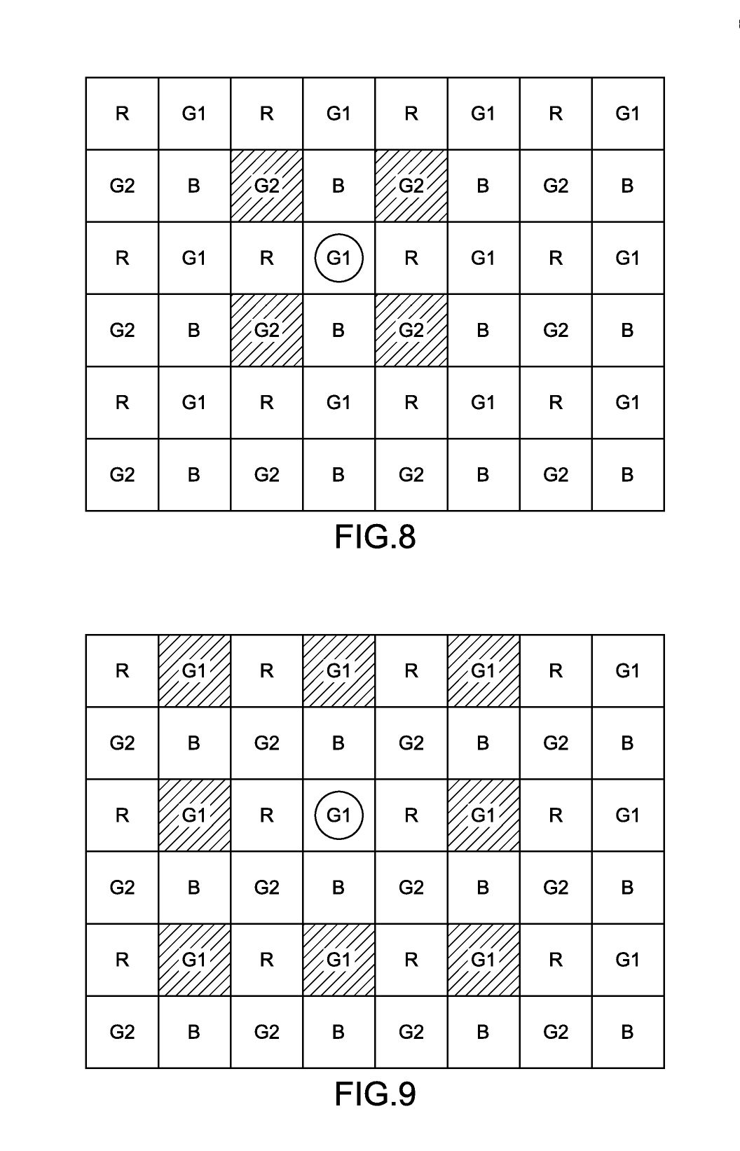

Next, three examples of median-filtered green pixels will be described. The circled pixel shows the position of the target pixel, and the hatched pixels show median-filtered pixels. FIG. 8 is a diagram showing the green target pixel G1 and median-filtered pixels (target pixel G1 and neighboring pixels G2, five in total) in the 1CCD RGB array.

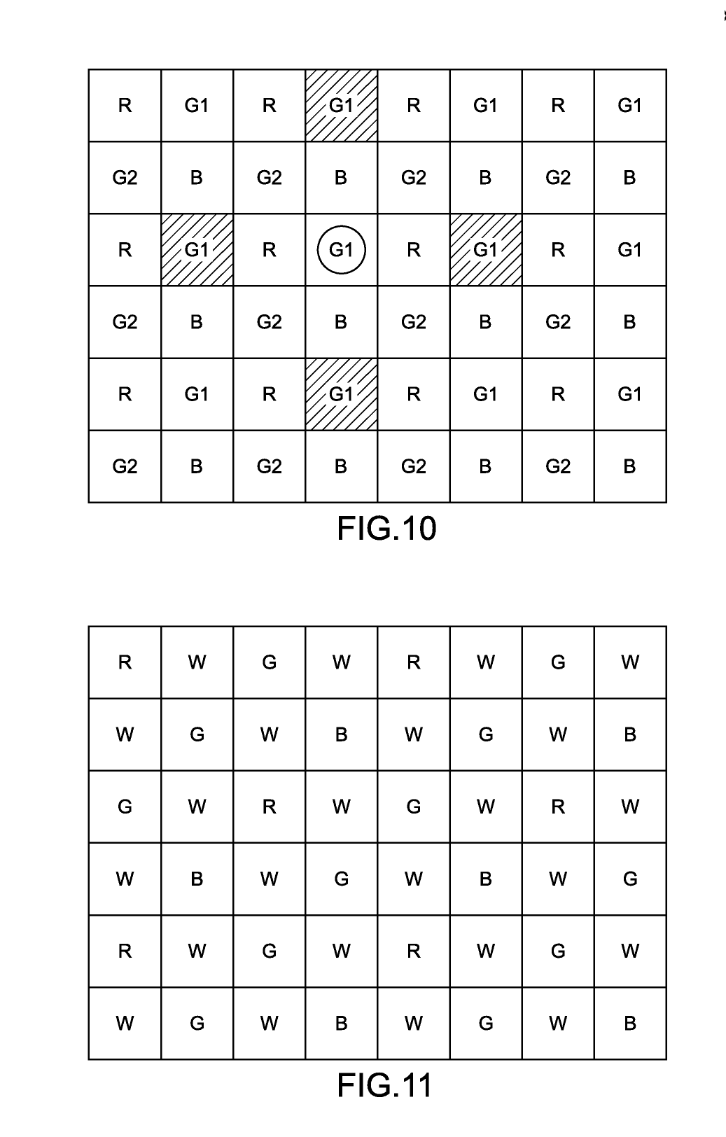

FIG. 9 is a diagram showing the green target pixel G1 and median-filtered pixels (target pixel G1 and neighboring pixels G1, nine in total) in the 1CCD RGB array. FIG. 10 is a diagram showing the green target pixel G1 and median-filtered pixels (target pixel G1 and neighboring pixels G1, five in total) in the 1CCD RGB array.

The cases where red, blue, and green pixels are median-filtered in the case where the pixel array of an image sensor is the 1CCD RGB array have been described above.

[Example 2 of Defective Pixel Detection Method (1CCD RGBW Array)]

Here, the defective pixel detection method, in which the pixel array of an image sensor is the 1CCD RGBW array, will be described. FIG. 11 is a diagram showing an example of the 1CCD RGBW array. R shows a pixel having a red optical filter. B shows a pixel having a blue optical filter. G shows a pixel having a green optical filter. W shows a pixel having a white optical filter.

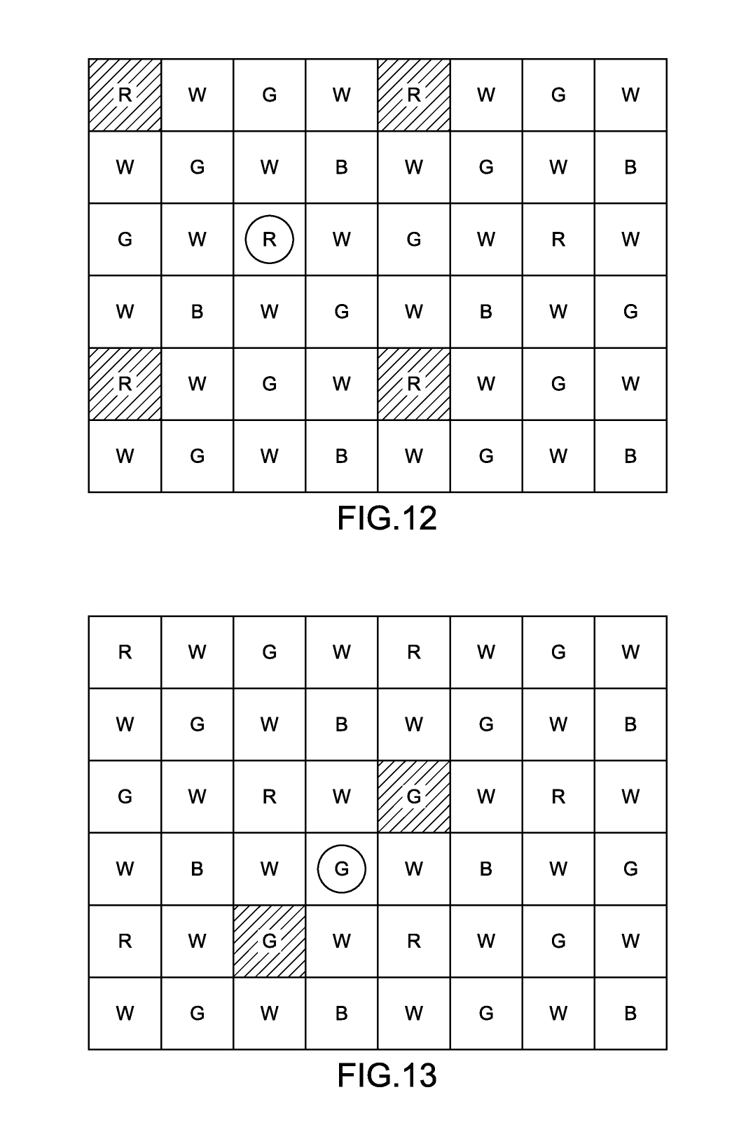

FIG. 12 is a diagram showing (five) median-filtered red pixels in the 1CCD RGBW array. As shown in FIG. 12, the luminance values of the four hatched pixels and the circled target pixel are median-filtered to determine a defect of the target pixel.

The case where red pixels are median-filtered has been described above. In the 1CCD RGBW array, the array of the blue pixels is the same as the array of the red pixels. So the blue pixels will not be described.

Next, an example of median-filtered green pixels will be described. The circled pixel shows the position of the target pixel, and the hatched pixels show median-filtered pixels. FIG. 13 is a diagram showing the green target pixel and median-filtered pixels (target pixel G and neighboring pixels G, three in total) in the 1CCD RGBW array.

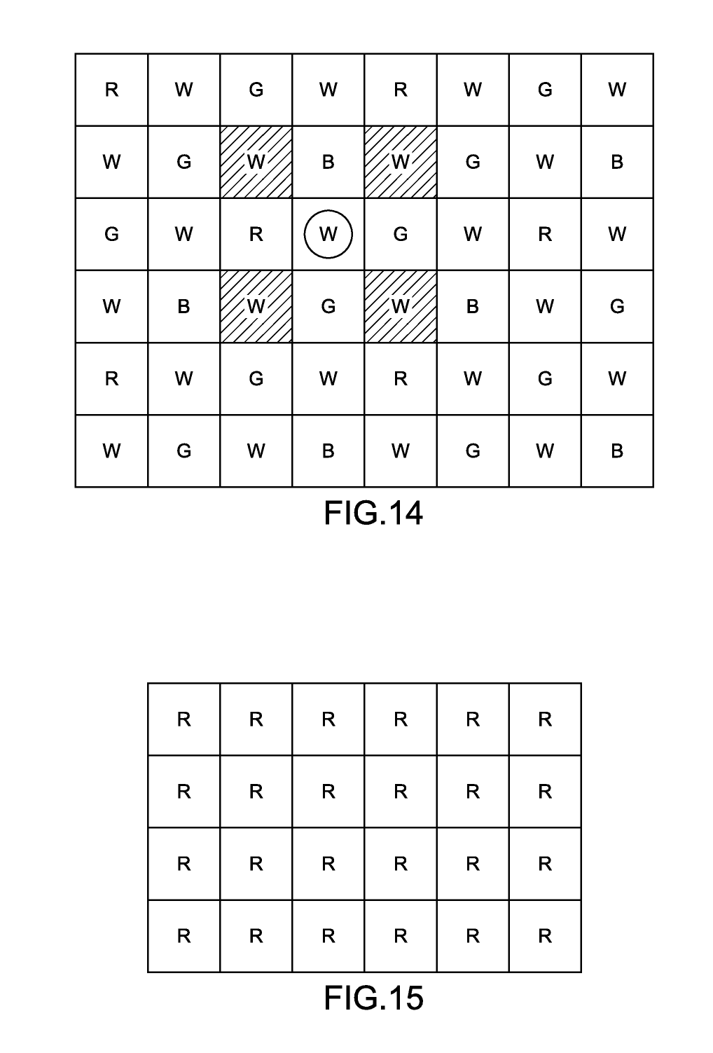

Next, an example of median-filtered white pixels will be described. FIG. 14 is a diagram showing the white target pixel and median-filtered pixels (target pixel W and neighboring pixels W, five in total) in the 1CCD RGBW array.

The cases where red, blue, green, and white pixels are median-filtered in the case where the pixel array of an image sensor is the 1CCD RGBW array have been described above.

[Example 3 of Defective Pixel Detection Method (3CCD RGB Array)]

Here, the defective pixel detection method, in which the pixel array of an image sensor is the 3CCD RGB array, will be described. FIG. 15 is a diagram showing an example of the array of the red image sensor of the 3CCD RGB array. The blue image sensor and the green image sensor have the same array, and are median-filtered by using the same method. So description thereof will be omitted.

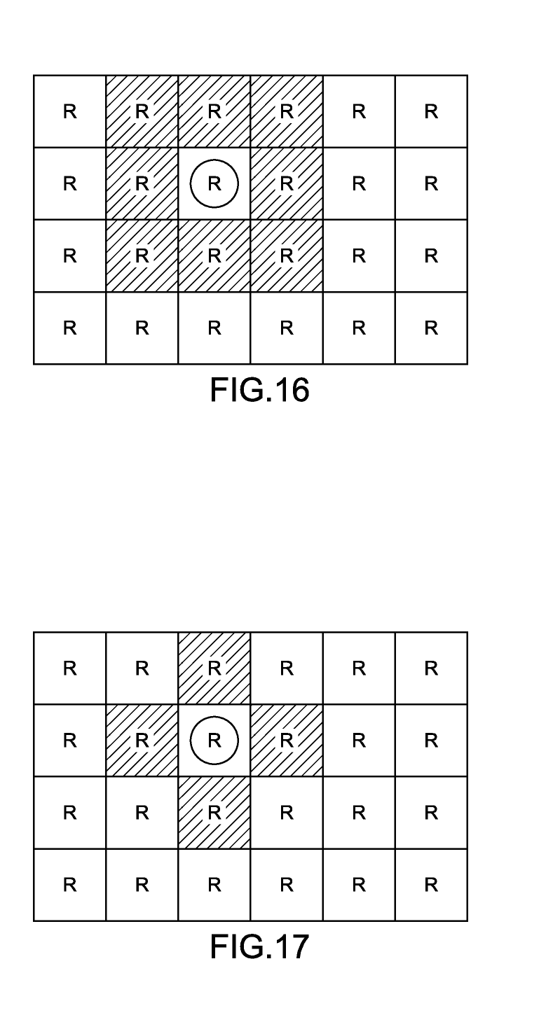

FIG. 16 is a diagram showing (nine) median-filtered red pixels in the 3CCD RGB array.

Note that, in FIG. 16, nine pixels are median-filtered in total. Alternatively, pixels, of which positions are shown in FIG. 17, may be median-filtered.

FIG. 17 is a diagram showing (five) median-filtered red pixels in the 3CCD RGB array.

The cases where red, blue, and green pixels are median-filtered in the case where the pixel array of an image sensor is the 3CCD RGB array have been described above.

[Example 4 of Defective Pixel Detection Method (1CCD Black-and-White Array)]

In the case where an image sensor has the 1CCD black-and-white array, the array is the same as the array of one of the three colors of the 3CCD RGB array. So description thereof will be omitted.

[Defective Position Data]

Defective position data is expressed by, for example, a matrix, which corresponds to the pixel arrangement of an image sensor. In the matrix, “1” shows the position of a normal pixel, and “0” shows the position of a defective pixel. By using the matrix having “0” and “1” element values, calculation may be made simple when a GPGPU corrects luminance values.

For example, the pixel array of an image sensor is the 1CCD RGB array. In this case, it is desirable to create a defective position matrix common to red and blue, and a defective position matrix dedicated to green. The reason is as follows. In the luminance value correction step, luminance value correction is divided into two processes, i.e., red and blue processing, and green processing. A defective position matrix used in the red and blue processing is different from a defective position matrix used in the green processing.

Note that a logical inversion matrix is also created, and is included in defective position data. The logical inversion matrix is obtained by logically inverting “0” and “1” of the defective position matrix. The logical inversion matrix is used in calculation when a GPGPU corrects defective pixel values.

[Defective Pixel Value Correction Processing]

A GPGPU corrects defective pixel values in order to speed up the correction processing. If a defective pixel value is corrected by using the median filter, the median value is used as a correction value. However, if a GPGPU is used to speed up the arithmetic processing, the median value is not used. Alternatively, the average value of neighboring pixels in the vicinity of a defective pixel is used to correct the luminance value of the defective pixel.

Note that it is confirmed that the correction result of the former is the same as the correction result of the latter from a practical standpoint. The reason is as follows. In most cases, a defective pixel is a single independent pixel. While a defective pixel has an outstanding luminance value, the neighboring pixels in the vicinity of the defective pixel have almost similar luminance values. Because of this, there is no great distinction between correction based on a median value and correction based on an average value when a user watches a corrected image with the eyes.

In addition, a key to speed up the defective pixel value correction processing is to use a calculation method optimized for a GPGPU if circumstances allow. The calculation method optimized for a GPGPU is as follows. Matrix addition, multiplication, element position movement, and bit shift are used in combination, and the average value of neighboring pixels in the vicinity of a defective pixel is obtained. Another key to speed up the defective pixel value correction processing is not to execute loop processing or conditional branching processing, and to increase parallel processing if circumstances allow.

Hereinafter, correction calculation methods of the above-mentioned examples, i.e., the 1CCD RGB array, the 1CCD RGBW array, the 3CCD RGB array, and the 1CCD black-and-white array, will be described.

[Example 1 of Defective Pixel Value Correction Method (1CCD RGB Array)]

Here, the defective pixel value correction method, in which the pixel array of an image sensor is the 1CCD RGB array, will be described. Note that, in the 1CCD RGB array, the red array method is the same as the blue array method, the red correction method is the same as the blue correction method, and the red correction method and the blue correction method may be executed simultaneously. So the red correction method will be described in the following example.

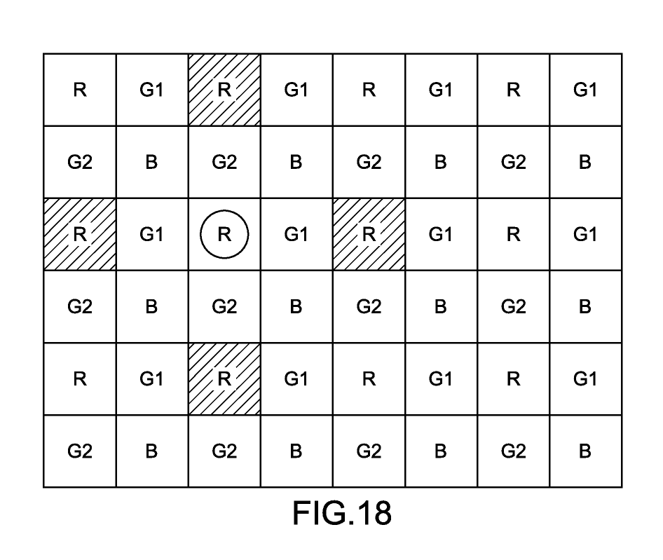

FIG. 18 is a diagram showing (four) red neighboring pixels of which average is obtained to correct a red defective pixel value in the 1CCD RGB array. In FIG. 18, the circled pixel shows a defective pixel. The hatched pixels around the circled pixel show neighboring pixels of which average is obtained to correct the luminance value of the defective pixel.

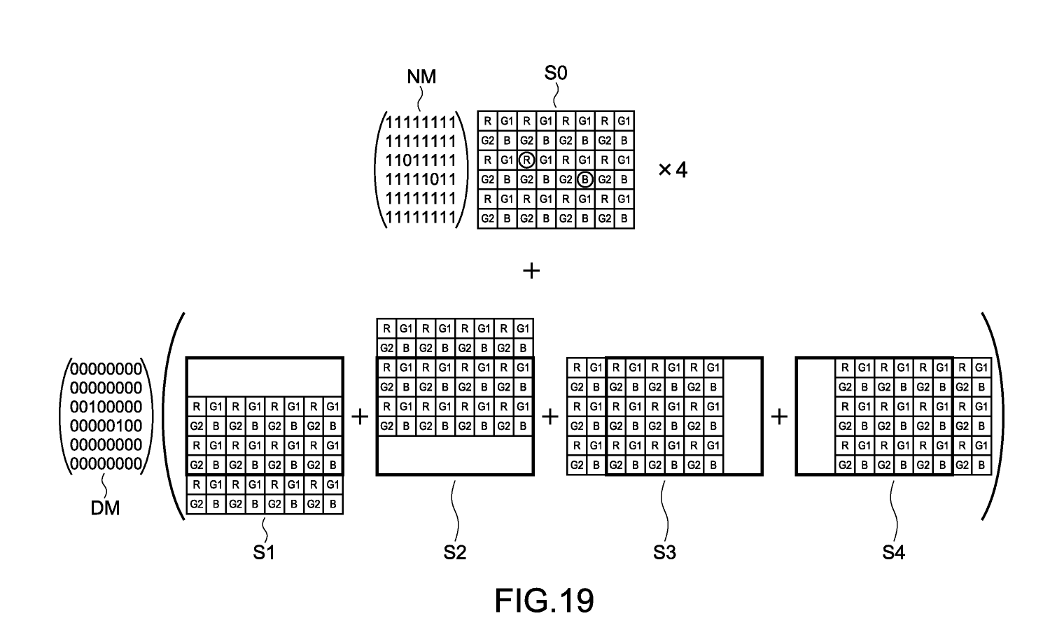

In FIG. 18, the position relation of the defective pixel and the neighboring pixels of which average value is obtained should be noted. Specifically, the four neighboring pixels are distant from the defective pixel by two pixels in the upper, lower, right, and left directions, respectively. FIG. 19 shows calculation suitable for a GPGPU, for example, with the above point in mind.

FIG. 19 is a diagram showing an example of a calculation method of correcting red and blue defective pixel values in the 1CCD RGB array. In FIG. 19, a position R and a position B of an original RAW image S0 are circled. The circles show the positions of defective pixels. A defective position matrix DM includes “1” at positions corresponding to the circles.

First, shift RAW images S1 to S4 are created. The pixel value of the shift RAW image S1 is different from the pixel value of the original RAW image S0 by two pixels in the upper direction. The pixel value of the shift RAW image S2 is different from the pixel value of the original RAW image S0 by two pixels in the lower direction. The pixel value of the shift RAW image S3 is different from the pixel value of the original RAW image S0 by two pixels in the right direction. The pixel value of the shift RAW image S4 is different from the pixel value of the original RAW image S0 by two pixels in the left direction. Further, the shift RAW images S1 to S4 are added for each pixel. The addition result will be temporarily referred to as “addition RAW image”. According to the above-mentioned calculation, addition processing of the luminance values of the hatched neighboring pixels in FIG. 18 is executed for all the pixels regardless of presence/absence of defects.

Presence/absence of defects is out of consideration in the above-mentioned calculation. In view of this, in the following calculation, the defective position matrix DM and a logical inversion matrix NM are used to select values based on presence/absence of defects.

The addition RAW image is obtained based on the above-mentioned calculation. First, the addition RAW image is multiplied by the defective position matrix DM. As a result, only addition results of defective positions are retrieved. Further, the quadruple of the original RAW image S0 is multiplied by the logical inversion matrix NM. As a result, the quadruple of the luminance values of positions other than the defective positions is retrieved. Finally, the sum of the addition result of the defective positions and the quadruple of the luminance values of positions other than the defective positions is obtained.

The red and blue correction calculation method of the 1CCD RGB array has been described above. The above-mentioned calculation is optimized for a GPGPU. The key of the calculation is that it does not include the loop processing or the conditional determination processing.

Note that, in a case of obtaining the average value of neighboring pixels, it is necessary to divide the sum by the number of added pixels at the end. This processing is executed when 8-bit processing is executed. The 8-bit processing is executed after RAW image development processing. So division is not executed herein.

Further, in the above-mentioned calculation, the numerical value “4” is used as much as possible. The reason is as follows. The quadruple is obtained by bit-shifting a digit position in the direction of carrying bits by 2 bits. The quarter is obtained by bit-shifting a digit position in the inverse direction by 2 bits. In this manner, the calculation is made simple.

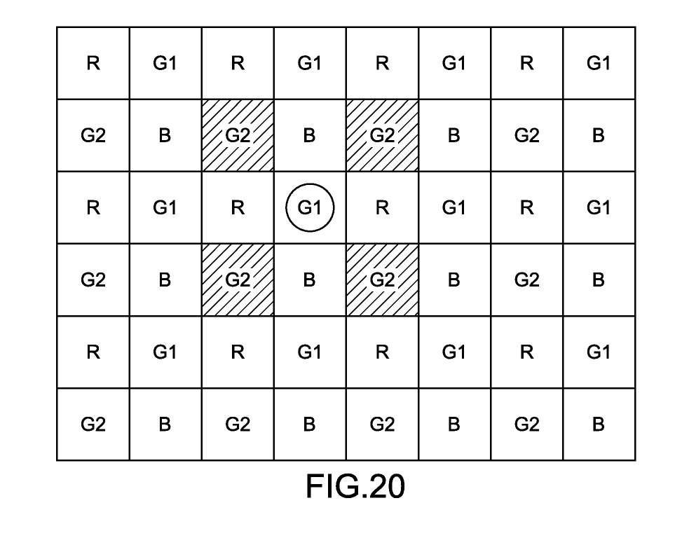

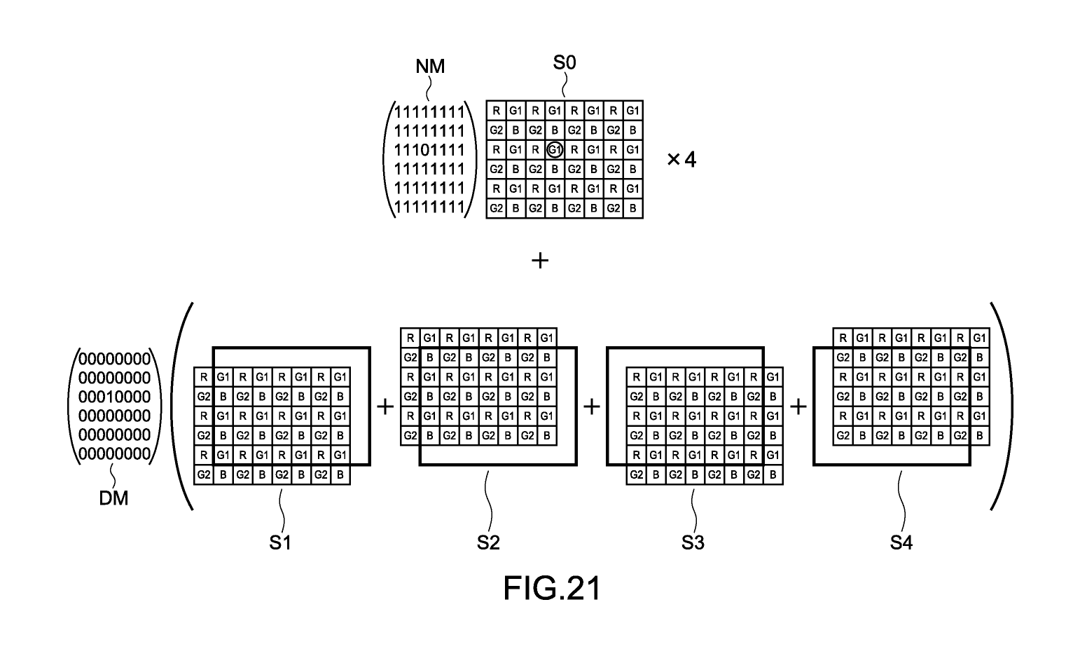

Next, the green correction of FIG. 8 will be described. FIG. 20 is a diagram showing (four) green neighboring pixels of which average is obtained to correct a green defective pixel value in the 1CCD RGB array. In FIG. 20, the circled pixel shows a defective pixel. The hatched pixels around the circled pixel show neighboring pixels of which average is obtained to correct the luminance value of the defective pixel. Further, FIG. 21 is a diagram showing an example of a calculation method of correcting green defective pixel values in the 1CCD RGB array.

Basically, the green correction method of FIG. 8 is similar to the red and blue correction method. Note that the neighboring pixels, of which average is obtained, are distant from the pixel, which has a to-be-corrected luminance value, by one pixel in the upper right, upper left, lower right, and lower left directions, respectively. Because of this, the following shift RAW images S1 to S4 are created. The shift RAW image S1 is different from the original RAW image S0 by one pixel in the upper right direction. The shift RAW image S2 is different from the original RAW image S0 by one pixel in the upper left direction. The shift RAW image S3 is different from the original RAW image S0 by one pixel in the lower right direction. The shift RAW image S4 is different from the original RAW image S0 by one pixel in the lower left direction. The green correction method is similar to the red and blue correction method except for the above. So description will be omitted. Note that the green pixel correction of FIG. 8 has been described above. However, the green correction method of FIG. 10 is similar to the red and blue correction method. In this case, it is possible to simultaneously correct red, blue, and green pixels by using the method of FIG. 19.

[Example 2 of Defective Pixel Value Correction Method (1CCD RGBW Array)]

Here, the defective pixel value correction method, in which the pixel array of an image sensor is the 1CCD RGBW array, will be described. Note that, in the 1CCD RGBW array, the red array method is the same as the blue array method, the red correction method is the same as the blue correction method, and the red correction method and the blue correction method may be executed simultaneously. So the red correction method will be described as the following example.

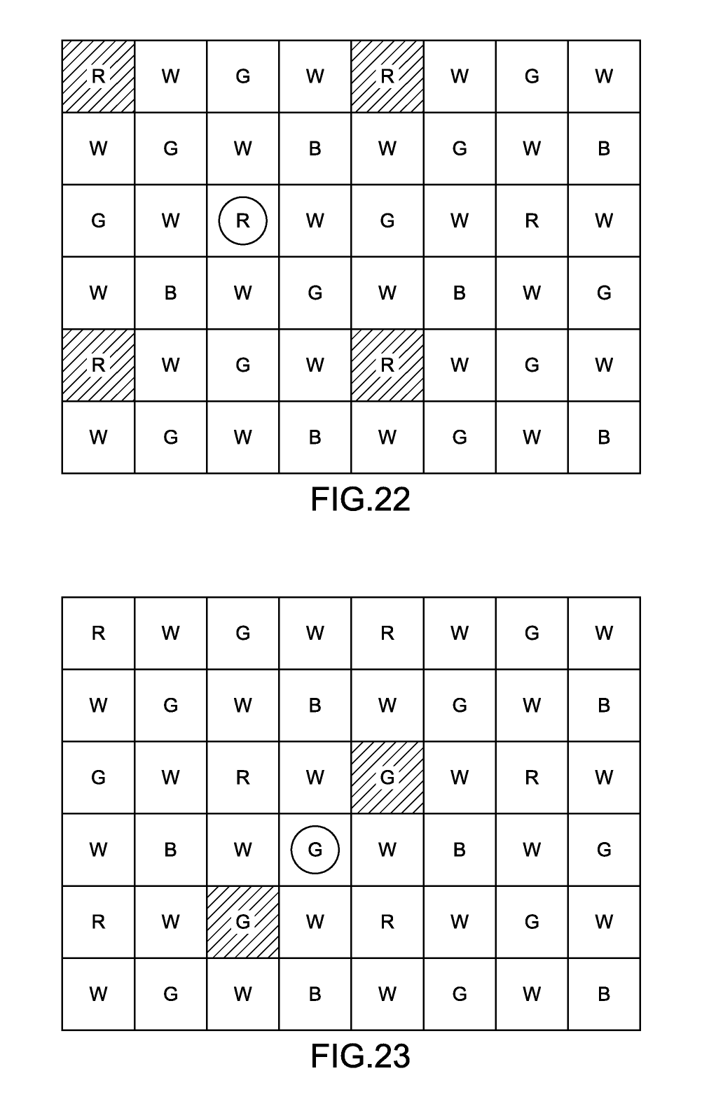

FIG. 22 is a diagram showing (four) red neighboring pixels of which average is obtained to correct a red defective pixel value in the 1CCD RGBW array. In FIG. 22, the circled pixel shows a defective pixel. The hatched pixels around the circled pixel show neighboring pixels of which average is obtained to correct the luminance value of the defective pixel.

As shown in FIG. 22, the red and blue correction of the 1CCD RGBW array is similar to the above-mentioned correction calculation method of the 1CCD RGB array except for the following. The following shift RAW images S1 to S4 are created. The shift RAW image S1 is different from the original RAW image S0 by two pixels in the upper right direction. The shift RAW image S2 is different from the original RAW image S0 by two pixels in the upper left direction. The shift RAW image S3 is different from the original RAW image S0 by two pixels in the lower right direction. The shift RAW image S4 is different from the original RAW image S0 by two pixels in the lower left direction. The red and blue correction of the 1CCD RGBW array is similar to the red and blue correction of the 1CCD RGB array. So description will be omitted.

FIG. 23 is a diagram showing (two) green neighboring pixels of which average is obtained to correct a green defective pixel value in the 1CCD RGBW array. There are only two neighboring pixels of which average value is obtained. The correction calculation method of the 1CCD RGBW array is different from the above-mentioned correction calculation method of the 1CCD RGB array as follows. That is, there are only two shift RAW images S1 and S2. The shift RAW image S1 is different from the original RAW image S0 by one pixel in the upper right direction. The shift RAW image S2 is different from the original RAW image S0 by one pixel in the upper left direction. Further, the original RAW image S0 is not quadrupled but doubled.

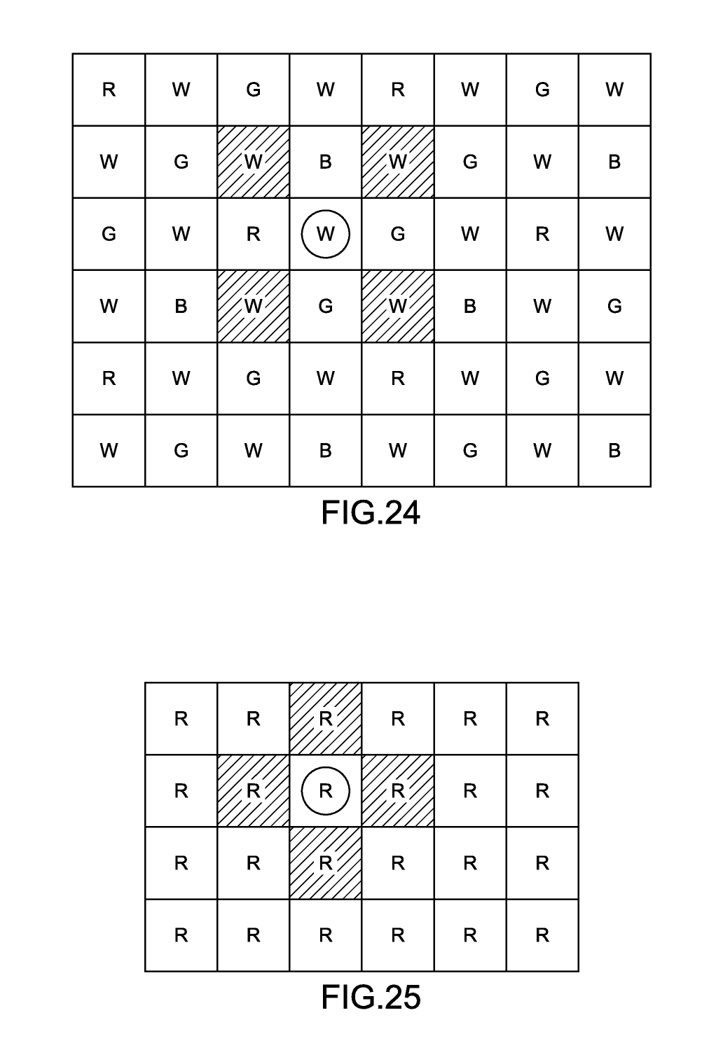

FIG. 24 is a diagram showing (four) white neighboring pixels of which average is obtained to correct a white defective pixel value in the 1CCD RGBW array. The following shift RAW images S1 to S4 are created. The shift RAW image S1 is different from the original RAW image S0 by one pixel in the upper right direction. The shift RAW image S2 is different from the original RAW image S0 by one pixel in the upper left direction. The shift RAW image S3 is different from the original RAW image S0 by one pixel in the lower right direction. The shift RAW image S4 is different from the original RAW image S0 by one pixel in the lower left direction.

[Example 3 of Defective Pixel Value Correction Method (3CCD RGB Array and 1CCD Black-and-White Array)]

Finally, an example of the defective pixel value correction method, in which the pixel array of an image sensor is the 3CCD RGB array or the 1CCD black-and-white array, will be described. The basic concept has been described above.

FIG. 25 is a diagram showing (four) unicolor neighboring pixels of which average is obtained to correct a unicolor defective pixel value in the 3CCD RGB array or the 1CCD black-and-white array. As shown in FIG. 25, the following shift RAW images S1 to S4 are created. The shift RAW image S1 is different from the original RAW image S0 by one pixel in the upper direction. The shift RAW image S2 is different from the original RAW image S0 by one pixel in the lower direction. The shift RAW image S3 is different from the original RAW image S0 by one pixel in the right direction. The shift RAW image S4 is different from the original RAW image S0 by one pixel in the left direction.

[Configuration of Image Obtaining Apparatus]

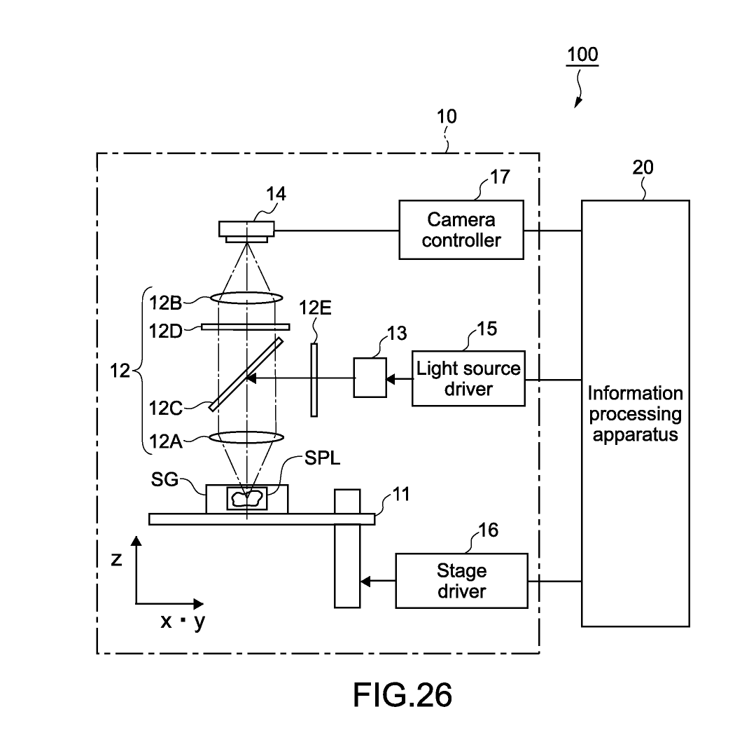

Next, the configuration of an information processing apparatus will be described. The information processing apparatus executes the above-mentioned defective pixel detection processing and the above-mentioned defective pixel value correction processing. FIG. 26 is a diagram showing the configuration of an image obtaining apparatus 100, which includes the information processing apparatus of this embodiment, and is configured to obtain a fluorescent image. Note that an example of the image obtaining apparatus 100 is a fluorescence microscope here. Alternatively, a bright field microscope may be employed.

The image obtaining apparatus 100 includes a fluorescence microscope 10 and an information processing apparatus 20.

The fluorescence microscope 10 includes a stage 11, an optical system 12, a light source 13, an image sensor 14, a light source driver 15, a stage driver 16, and a camera controller 17.

The stage 11 has a surface, on which a biological sample SPL as an object of shooting may be arranged. Examples of the biological sample SPL include a slice of tissue, cells, a chromosome, and the like. The stage 11 is capable of moving in the directions (x-axis and y-axis directions) parallel to the surface, and in the direction (z-axis direction) orthogonal to the surface.

The optical system 12 is arranged above the stage 11. The optical system 12 includes an objective lens 12A, an imaging lens 12B, a dichroic mirror 12C, an emission filter 12D, and an excitation filter 12E.

In a case of obtaining a fluorescent image of the biological sample SPL, the excitation filter 12E only causes light, which has an excitation wavelength for exciting fluorescent dye, to pass through, out of light emitted from the light source 13, to thereby generate an excitation light. The excitation light, which has passed through the excitation filter and enters the dichroic mirror 12C, is reflected by the dichroic mirror 12C, and is guided to the objective lens 12A. The objective lens 12A condenses the excitation light on the biological sample SPL. Then, the objective lens 12A and the imaging lens 12B magnify the image of the biological sample SPL at a predetermined power, and form the magnified image in an imaging area of the image sensor 14.

The light source 13 is, for example, a light bulb such as a mercury lamp, an LED (Light Emitting Diode), or the like. Fluorescent labels in a biological sample are irradiated with an excitation light from the light source 13.

When the biological sample SPL is irradiated with the excitation light, the stain emits fluorescence. The stain is bound to each tissue of the biological sample SPL. The fluorescence passes through the dichroic mirror 12C via the objective lens 12A, and reaches the imaging lens 12B via the emission filter 12D.

The emission filter 12D absorbs light, which has passed through the excitation filter 12E, and is magnified by the above-mentioned objective lens 12A. Only a part of colored light passes through the emission filter 12D. As described above, the imaging lens 12B magnifies an image of the color light, from which outside light is lost. The imaging lens 12B forms an image on the image sensor 14.

As the image sensor 14, for example, a CCD (Charge Coupled Device) image sensor, a CMOS (Complementary Metal Oxide Semiconductor) image sensor, or the like is used. In such an image sensor, all the light receiving sections, which correspond to all the pixels, are capable of being exposed simultaneously.

The light source driver 15 at least includes a drive circuit. The drive circuit supplies constant drive current to the light source 13A in response to a light emission instruction S1 from the information processing apparatus 20, and causes the light source 13A to emit light.

The stage driver 16 supplies stage drive current in the three-axis (x, y, and z) directions for driving the stage 11 in response to a stage control signal S2 from the information processing apparatus 20, and causes the stage 11 to move in the three-axis directions.

The camera controller 17 controls the image sensor 14 in response to an exposure control signal S3 from the information processing apparatus 20. The camera controller 17 A/D (Analog to Digital)-converts signals (RAW data) corresponding to pixels retrieved by the image sensor 14. The camera controller 17 supplies the A/D-converted signals to the information processing apparatus 20.

The information processing apparatus 20 processes (image processing, described later) RAW data, which is supplied from the camera controller 17 of the microscope 10. The information processing apparatus 20 stores the processed image. Further, the information processing apparatus 20 executes arithmetic processing for controlling the light source driver 15, the stage driver 16, and the camera controller 17 based on predetermined programs.

[Configuration of Information Processing Apparatus 20]

Next, the hardware configuration of the information processing apparatus 20 will be described.

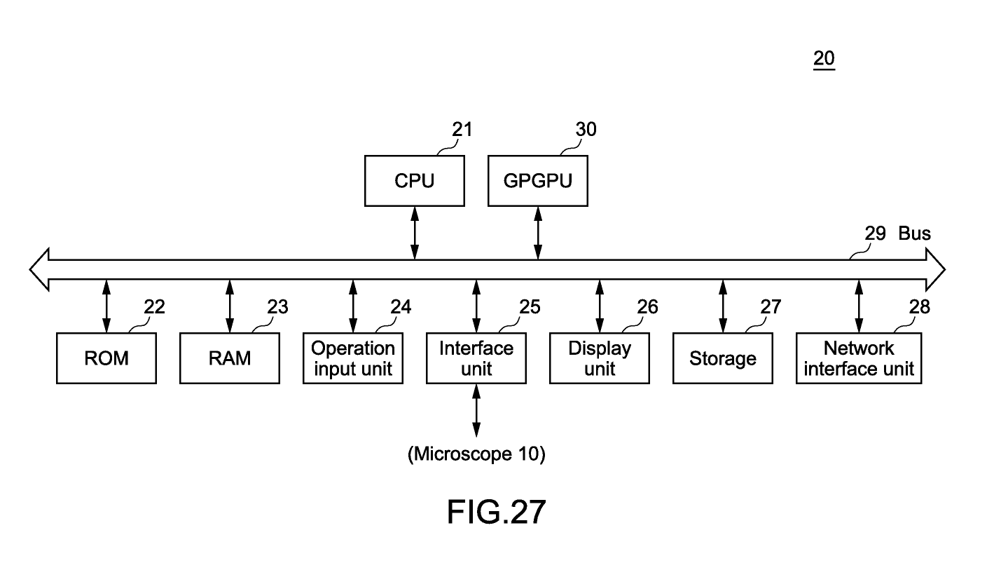

FIG. 27 is a block diagram showing the hardware configuration of the information processing apparatus 20 of the present technology.

The information processing apparatus 20 includes a CPU (Central Processing Unit) 21 (controller, first arithmetic processor), a ROM (Read Only Memory) 22, a RAM (Random Access Memory) 23, an operation input unit 24, an interface unit 25, a display unit 26, storage 27, a network interface unit 28, a GPGPU (General-purpose calculation on graphics processors) 30 (controller, second arithmetic processor), and a bus 29 connecting them. The CPU 21 performs arithmetic control. The RAM 23 is a work memory for the CPU 21. Instructions depending on operation by a user are input in the operation input unit 24.

Programs for executing various processes are stored in the ROM 22. The microscope 10 is connected to the interface unit 25. A network is connected to the network interface unit 28.

The display unit 26 is a liquid crystal display, an EL (Electro Luminescence) display, a plasma display, or the like. The storage 27 is a magnetic disk such as an HDD (Hard Disk Drive), a semiconductor memory, an optical disk, or the like.

The CPU 21 expands a program corresponding to an instruction from the operation input unit 24, out of a plurality of programs stored in the ROM 22, in the RAM 23. The CPU 21 arbitrarily controls the display unit 26 and the storage 27 based on the expanded program. Further, the CPU 21 as necessary controls the respective units of the microscope 10 via the interface unit 25 based on the programs developed in the RAM 23.

The GPGPU 30 is capable of executing image processing such as RAW image correction processing, shading processing, and JPEG processing in parallel.

The CPU 21 and the GPGPU 30 implement functional blocks (described later). The CPU 21 executes the programs stored in the ROM 22, the storage 27, and the like. The CPU 21 as necessary controls the above-mentioned units. Because of this, the information processing apparatus 20 is capable of implementing the various functional blocks. The information processing apparatus 20 is capable of causing the respective unit to function as the information processing apparatus 20.

[Functional Blocks of Information Processing Apparatus 20]

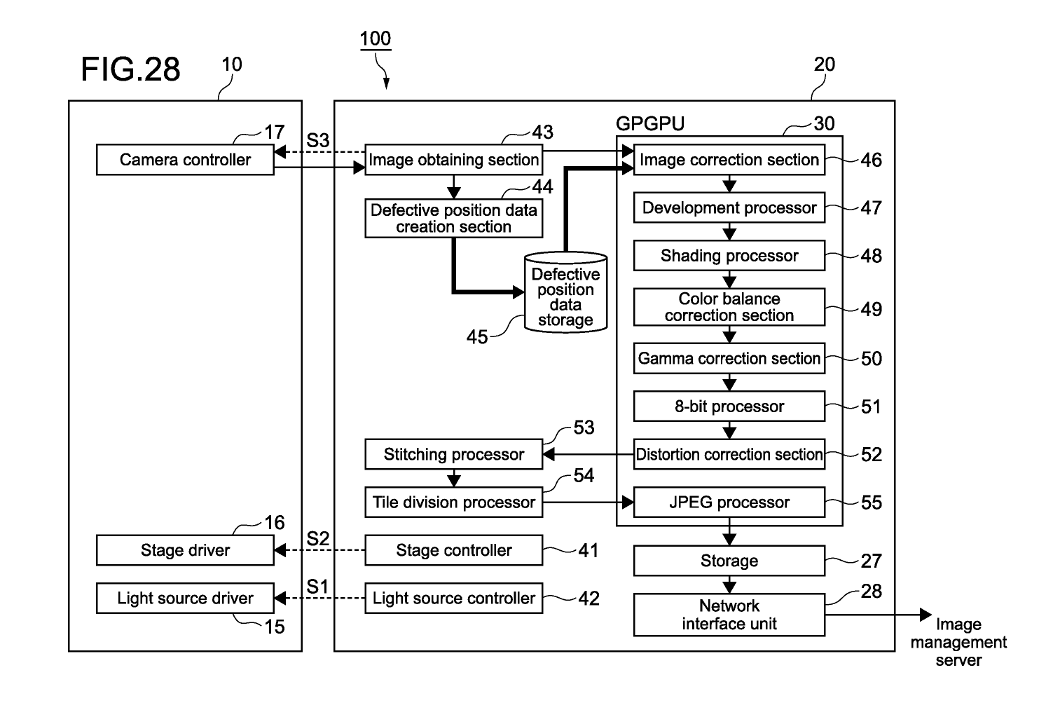

FIG. 28 is a functional block diagram showing the information processing apparatus 20 of the present technology. Note that, in FIG. 28, the solid arrows show the flow of shot image data in the information processing apparatus 20. Further, the bold arrows show the flow of position defective data. The position defective data shows positions of defective pixels of the image sensor 14.

Note that, in the preliminary photographing, an image obtaining section 43, a defective position data creation section 44, and defective position data storage 45 function in this order. In the actual photographing, the image obtaining section 43, the defective position data storage 45, an image correction section 46, a development processor 47, a shading processor 48, a color balance correction section 49, a gamma correction section 50, an 8-bit processor 51, and a distortion correction section 52 function in this order. Further, in the actual photographing, a stitching processor 53, a tile division processor 54, and a JPEG processor 55 process an image in this order. The storage 27 temporarily stores the processed image. After that, the processed image is uploaded to an image management server via the network interface unit 28.

As shown in FIG. 27, the CPU 21 functions as a stage controller 41, a light source controller 42, the image obtaining section 43 (image obtaining section), the defective position data creation section 44, the stitching processor 53, and the tile division processor 54 based on the following programs. One program causes the CPU 21 to specify positions of defective pixels of the image sensor 14. The other program corresponds to an instruction to create an 8-bit JPEG color image.

Further, the GPGPU 30 functions as the image correction section 46, the development processor 47, the shading processor 48, the color balance correction section 49, the gamma correction section 50, the 8-bit processor 51, the distortion correction section 52, and the JPEG processor 55 based on the following programs. One program causes the GPGPU 30 to correct luminance values of defective pixels. The other program corresponds to the instruction to create an 8-bit JPEG color image.

Further, the storage 27 functions as the defective position data storage 45.

The stage controller 41 controls the stage driver 16 by sending a control signal S2 to the stage driver 16, to thereby move the stage 11.

The light source controller 42 controls the light source driver 15 by sending a control signal S1 to the light source driver 15, to thereby control the light source 13A.

The image obtaining section 43 controls the camera controller 17 by sending a signal S3 to the camera controller 17, to thereby set various photographing conditions and to take an image. The image obtaining section 43 obtains a shot image as a RAW image from the image sensor 14 via the camera controller 17.

The image sensor 14 takes a RAW image in the preliminary photographing. The defective position data creation section 44 obtains the RAW image from the image obtaining section 43. The defective position data creation section 44 specifies defective positions of the image sensor 14 by using the median filter. The defective position data creation section 44 creates defective position data. The defective position data storage 45 stores the created defective position data.

The defective position data storage 45 stores the defective position data, which is created by the defective position data creation section 44. The defective position data storage 45 supplies the defective position data to the image correction section 46 as necessary.

The image correction section 46 corrects defects of pixels in the RAW image based on the defective position data. Here, the RAW image is received from the image obtaining section 43. The defective position data is received from the defective position data storage 45. The image correction section 46 corrects defects of pixels by replacing the luminance value of a defective pixel with the average of the luminance values of neighboring pixels.

The development processor 47 develops (demosaics) the RAW image, and obtains a color image. Here, the image obtaining section 43 obtains the RAW image, and the image correction section 46 corrects the RAW image.

The shading processor 48 applies shading processing to the image, which is developed by the development processor 47. The color balance correction section 49 corrects the color balance (white balance) of the shading-processed image. As a result, portions, which should be uncolored originally, are corrected to be uncolored. The gamma correction section 50 applies gamma correction to the image, of which color balance is corrected. As a result, the relative relation between color data and a signal, which actually outputs the color data, is adjusted.

The 8-bit processor 51 changes the gradation value of the gamma-corrected image from 16 bits to 8 bits. The distortion correction section 52 applies distortion correction to the 8-bit image, and corrects distortion of a lens.

The stitching processor 53 applies stitching processing to a plurality of images, to which distortion correction is applied. The stitching processor 53 obtains relative position information of neighboring images. The stitching processor 53 stitches adjacent images in this manner.

The tile division processor 54 divides the stitched image into tiles in order to speed up image display. Note that the tile division processing is executed in order to display image data at high speed. The tile division processing is not always necessary. The JPEG processor 55 obtains a JPEG image of the image, which is divided into tiles. The storage 27 stores the JPEG image. After that, the JPEG image is uploaded to the image management server (not shown) via the network interface unit 28. A user browses the JPEG image.

[Flow of Defective Pixel Detection Processing and Defective Pixel Value Correction Processing]

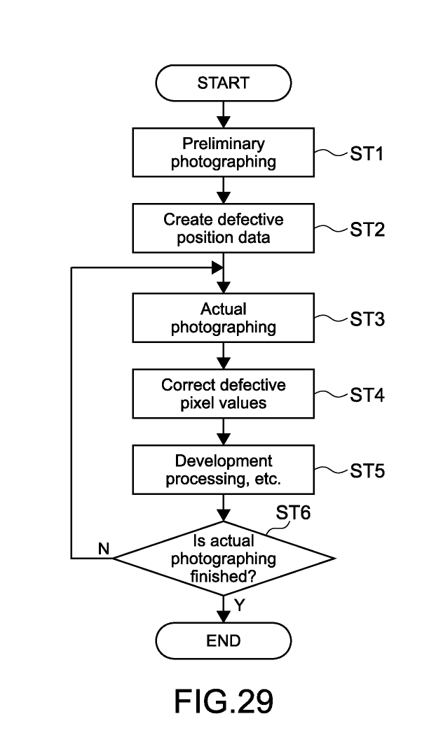

Next, the overall flow of defective pixel detection and defective pixel value correction will be described. FIG. 29 is a flowchart showing the overall flow of defective pixel detection and defective pixel value correction.

First, the image obtaining section 43 causes the image sensor 14 to perform preliminary photographing via the light source driver 15 and the camera controller 17. The image sensor 14 performs preliminary photographing under a photographing condition for preliminary photographing. The image obtaining section 43 obtains a RAW image taken in the preliminary photographing (Step ST1). The image obtaining section 43 supplies the obtained RAW image to the defective position data creation section 44.

Next, the defective position data creation section 44 median-filters the RAW image, which is obtained from the image obtaining section 43, as described above. As a result, the defective position data creation section 44 detects defective pixels. The defective position data creation section 44 creates the positions of the detected defective pixels as defective position data (Step ST2). The defective position data includes the defective position matrix DM and the logical inversion matrix NM. The defective position data creation section 44 stores the created defective position data in the defective position data storage 45.

Next, the image obtaining section 43 causes the image sensor 14 to perform actual photographing via the light source driver 15 and the camera controller 17. The image sensor 14 performs actual photographing under a photographing condition for the actual photographing. The image obtaining section 43 obtains a RAW image taken in the actual photographing (Step ST3). The image obtaining section 43 supplies the obtained RAW image to the image correction section 46.

Next, the image correction section 46 corrects defective pixel values based on the RAW image and the defective position data (Step ST4). Here, the RAW image is supplied from the image obtaining section 43. The defective position data is retrieved from the defective position data storage 45. The correction method has been described above. The image correction section 46 supplies the corrected RAW image to the development processor 47.

Next, the development processor 47 develops the supplied RAW image. The shading processor 48, the color balance correction section 49, the gamma correction section 50, the 8-bit processor 51, the distortion correction section 52, and the stitching processor 53 process the developed image in this order. Further, the tile division processor 54 and the JPEG processor 55 process the processed image in this order. The storage 27 temporarily stores the processed image (Step ST5).

The processing from the actual photographing (Step ST3) to storing of an image, which is obtained in the actual photographing, in the storage 27 (Step ST5) is repeated until an object of actual photographing is lost (Step ST6, N).

The overall flow of defective pixel detection and defective pixel value correction has been described above.

[Other Configurations of Present Technology]

Note that the present technology may employ the following configurations.

(1) An information processing apparatus, comprising:

an image obtaining section configured to obtain a RAW image, the RAW image being taken by an imaging unit, the imaging unit including an image sensor; and

a controller configured
to cause the imaging unit to preliminarily photograph a preliminary photographing object, and to obtain the RAW image as a first RAW image,
to specify a defective pixel of the first RAW image based on the amount of difference between a value of a target pixel and a value of a neighboring pixel around the target pixel, and to create defective position data,
to cause the imaging unit to actually photograph an actual photographing object, and to obtain the RAW image as a second RAW image, and
to correct a luminance value of the second RAW image based on the defective position data.
   (2) The information processing apparatus according to (1), wherein

the controller includes
a first arithmetic processor configured
   to cause the imaging unit to preliminarily photograph a preliminary photographing object, and to obtain the first RAW image,
   to specify a defective pixel of the first RAW image based on the amount of difference between a value of a target pixel and a value of a neighboring pixel around the target pixel, and to create defective position data, and
   to cause the imaging unit to actually photograph an actual photographing object, and
a second arithmetic processor configured to correct a luminance value of the second RAW image based on the defective position data, the second RAW image being obtained by the actual photographing.
   (3) The information processing apparatus according to (2), wherein

the second arithmetic processor is configured
to calculate an average of luminance values of neighboring pixels around a defective position for each pixel color, and
to correct the luminance value of the defective position with the average value.
   (4) The information processing apparatus according to (2) or (3), wherein

the first arithmetic processor is configured to set a photographing condition in the imaging unit, the photographing condition of the preliminary photographing being capable of emphasizing a defective characteristic of each pixel of the image sensor more than a photographing condition of the actual photographing does.

(5) The information processing apparatus according to any one of (2) to (4), wherein

the second arithmetic processor is a graphics processing unit.

(6) An information processing method, comprising:

obtaining, by an image obtaining section, a RAW image, the RAW image being taken by an imaging unit, the imaging unit including an image sensor;

causing, by a controller, the imaging unit to preliminarily photograph a preliminary photographing object, and to obtain the RAW image as a first RAW image;

specifying, by the controller, a defective pixel of the first RAW image based on the amount of difference between a value of a target pixel and a value of a neighboring pixel around the target pixel, and to create defective position data;

causing, by the controller, the imaging unit to actually photograph an actual photographing object, and to obtain the RAW image as a second RAW image; and

correcting, by the controller, a luminance value of the second RAW image based on the defective position data.

(7) An information processing program, causing a computer to function as:

an image obtaining section configured to obtain a RAW image, the RAW image being taken by an imaging unit, the imaging unit including an image sensor; and

a controller configured
to cause the imaging unit to preliminarily photograph a preliminary photographing object, and to obtain the RAW image as a first RAW image,
to specify a defective pixel of the first RAW image based on the amount of difference between a value of a target pixel and a value of a neighboring pixel around the target pixel, and to create defective position data,
to cause the imaging unit to actually photograph an actual photographing object, and to obtain the RAW image as a second RAW image, and
to correct a luminance value of the second RAW image based on the defective position data.

[Supplementary Note]

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-157242 filed in the Japan Patent Office on Jul. 13, 2012, the entire content of which is hereby incorporated by reference.

What is claimed is:

1. An information processing apparatus, comprising:
an image obtaining section configured to obtain a RAW image, the RAW image being taken by an imaging unit, the imaging unit including an image sensor; and
a controller configured
to cause the imaging unit to preliminarily photograph a preliminary photographing object, and to obtain the RAW image as a first RAW image,
to specify a defective pixel of the first RAW image based on the amount of difference between a value of a target pixel and a value of a neighboring pixel around the target pixel, and to create defective position data,
to cause the imaging unit to actually photograph an actual photographing object, and to obtain the RAW image as a second RAW image, and
to correct a luminance value of the second RAW image based on the defective position data.

2. The information processing apparatus according to claim 1, wherein
the controller includes
a first arithmetic processor configured
to cause the imaging unit to preliminarily photograph a preliminary photographing object, and to obtain the first RAW image,
to specify a defective pixel of the first RAW image based on the amount of difference between a value of a target pixel and a value of a neighboring pixel around the target pixel, and to create defective position data, and
to cause the imaging unit to actually photograph an actual photographing object, and
a second arithmetic processor configured to correct a luminance value of the second RAW image based on the defective position data, the second RAW image being obtained by the actual photographing.

3. The information processing apparatus according to claim 2, wherein
the second arithmetic processor is configured
to calculate an average of luminance values of neighboring pixels around a defective position for each pixel color, and
to correct the luminance value of the defective position with the average value.

4. The information processing apparatus according to claim 3, wherein
the first arithmetic processor is configured to set a photographing condition in the imaging unit, the photographing condition of the preliminary photographing being capable of emphasizing a defective characteristic of each pixel of the image sensor more than a photographing condition of the actual photographing does.

5. The information processing apparatus according to claim 4, wherein
the second arithmetic processor is a graphics processing unit.

6. An information processing method, comprising:
obtaining, by an image obtaining section, a RAW image, the RAW image being taken by an imaging unit, the imaging unit including an image sensor;
causing, by a controller, the imaging unit to preliminarily photograph a preliminary photographing object, and to obtain the RAW image as a first RAW image;
specifying, by the controller, a defective pixel of the first RAW image based on the amount of difference between a value of a target pixel and a value of a neighboring pixel around the target pixel, and to create defective position data;
causing, by the controller, the imaging unit to actually photograph an actual photographing object, and to obtain the RAW image as a second RAW image; and
correcting, by the controller, a luminance value of the second RAW image based on the defective position data.

7. An information processing program, causing a computer to function as:
an image obtaining section configured to obtain a RAW image, the RAW image being taken by an imaging unit, the imaging unit including an image sensor; and
a controller configured
to cause the imaging unit to preliminarily photograph a preliminary photographing object, and to obtain the RAW image as a first RAW image,
to specify a defective pixel of the first RAW image based on the amount of difference between a value of a target pixel and a value of a neighboring pixel around the target pixel, and to create defective position data,
to cause the imaging unit to actually photograph an actual photographing object, and to obtain the RAW image as a second RAW image, and
to correct a luminance value of the second RAW image based on the defective position data.
